(19) United States
(12) Patent Application Publication
(10) Pub. No.: US 2004/0093849 A1
(43) Pub. Date: May 20, 2004

(54) Anti-back flex chain

(76) Inventors: Timothy N. Thomas, St.Clair Shores, MI (US); Bradley R. Carver, Roseville, MI (US)

Correspondence Address: Andrew R. Basile, Young & Basile, P.C., Suite 624, 3001 West Big Beaver Road, Troy, MI, 48084, US

(21) Appl. No.: 10/701,712

(22) Filed: Nov. 5, 2003

Related U.S. Application Data
(60) Provisional application No. 60/423,769, filed on Nov. 5, 2002.

(51) Int. Cl. F16G 13/06

(52) U.S. Cl. 59/84

(57) ABSTRACT

A preferred embodiment of an anti-backflex chain includes one or more connecting links pivotally attached to one or more roller links. The connecting links and the roller links each include a blocking member attached to a pair of side plates. The blocking member is attached to a link at a point latterly displaced from a longitudinal axis of the link. The blocking members attached to the connecting links have an exterior periphery engageable with an exterior periphery of the blocking members attached to the roller links. The blocking members function as stops to prevent further pivotal movement of the connecting link relative to an adjacent roller link. The blocking members may have a variety of shapes, including cylindrical and box-shaped. Multiple connecting links can be attached to multiple roller links to create a chain of a desired length.

### RELATED APPLICATIONS

This application is a continuation of a U.S. Provisional Application Serial No. 60/423,769 filed Nov. 5, 2002.

### FIELD OF THE INVENTION

The present invention relates to a chain, and more particularly, to a chain having limited range of motion in at least one direction.

### BACKGROUND AND SUMMARY OF THE INVENTION

Chains typically are composed of several links and are generally flexible in at least one plane. Chains have a variety of uses, including hoisting and power transmission. It may be desirable in certain instances, however, to limit a chain's range of motion in at least one direction.

In accordance with the present invention, a preferred embodiment of an anti-backflex chain is disclosed. The chain includes one or more connecting links pivotally attached to one or more roller links. The connecting links and the roller links each include a blocking member attached to a pair of side plates. The blocking member is attached to a link at a point latterly displaced from a longitudinal axis of the link. The blocking members attached to the connecting links have an exterior periphery engageable with an exterior periphery of the blocking members attached to the roller links. The blocking members function as stops to prevent further pivotal movement of the connecting link relative to an adjacent roller link. The blocking members may have a variety of shapes, including cylindrical and box-shaped. Multiple connecting links can be attached together to create a chain of a desired length.

Further areas of applicability of the present invention will become apparent from the detailed description provided hereinafter. It should be understood that the detailed description and specific examples, while indicating preferred embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a roller link and an exploded perspective view of a connecting link employed in a preferred embodiment of an anti-back flex chain; and

FIG. 2 is perspective view of a roller link and an exploded perspective view of a connecting link employed in an alternate embodiment of the anti-back flex chain.

### DESCRIPTION OF THE PREFERRED EMBODIMENT

The following description of the preferred embodiments is merely exemplary in nature and is in no way intended to limit the invention, its application, or uses.

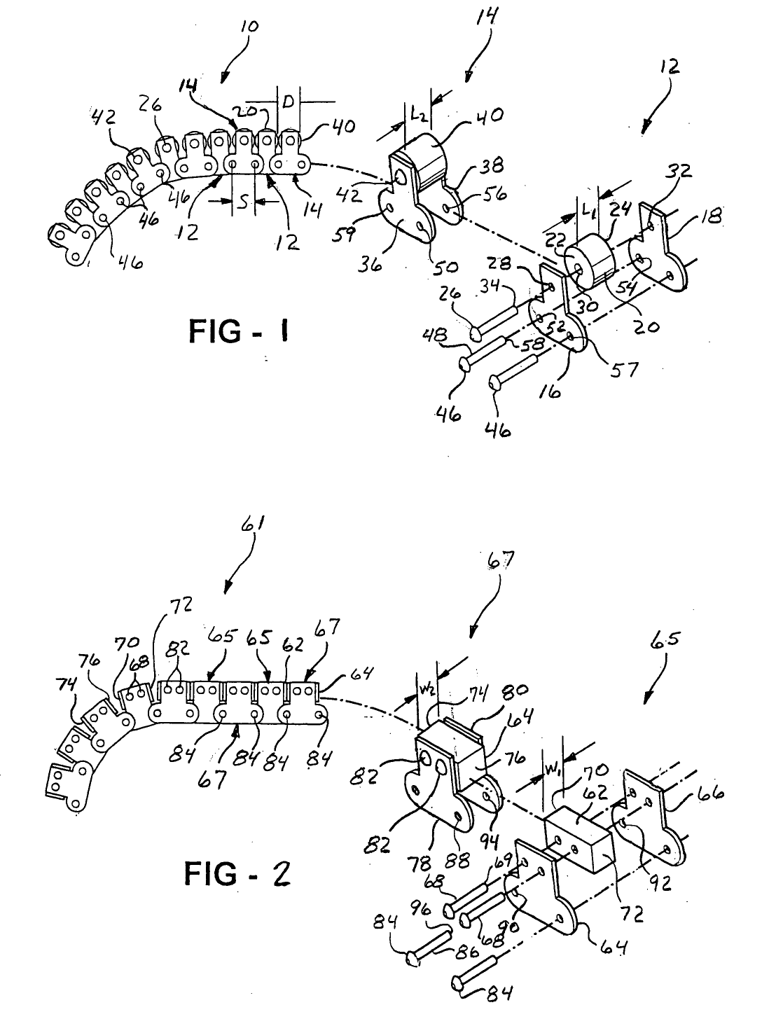

Referring to FIG. 1, a chain 10 is shown to include one or more connecting links 12 pivotally connected to one or more roller links 14. The links are connected together in an alternating fashion, whereby each of the connecting links 12 is separated by one of the roller links 14, and vise versa. Multiple links 12 and 14 can be connected together to produced a chain of a desired length.

The connecting links 12 include a first side plate 16. Positioned adjacent to the first side plate 16 is a second side plate 18. The side plates 16 and 18 are each shown to include a projection extending latterly outward from the plate. This results in the sides plate 16 and 18 having a shape resembling an inverted “T”. Alternatively, the side plates 16 and 18 may be configured in any of a variety of other shapes without substantially impacting the functional characteristics of the plates, such as square, triangle, rectangle, trapezoid, or another functionally equivalent shape. The side plates 16 and 18 preferably have the same shape, thereby enabling the plates to be used interchangeably. The “T” shaped configuration is desirable because it minimizes the amount of material used as compared to other configurations, which may reduce the weight of the chain.

The connecting links 12 further include a blocking member 20 retentively positioned between the first side plate 16 and the second side plate 18. The blocking member 20 acts as a spacer for positioning the first side plate 16 relative to the second side plate 18, while also functioning to limit the amount of rotational movement between the links 12 and 14. This latter aspect of the invention is discussed in more detail subsequently.

The blocking member 20 preferably has a cylindrical shape that may assist in discharging contaminants that may accumulate between adjacent blocking members. A longitudinal axis of the blocking member 20 is oriented substantially perpendicular to the side plates 16 and 18. The blocking member 20 has a first end 22 positioned adjacent to the first side plate 16 and a second end 24 positioned adjacent to the second side plate 18.

The blocking member 20 is fixedly retained between the side plates 16 and 18 using a pin 26. The pin 26 is engageable with an aperture 28 positioned in the first side plate 16, a bore 30 passing through the blocking member 20 and having its longitudinal axis aligned substantially to coincide with the longitudinal axis of the blocking member 20, and an aperture 32 positioned in the second side plate 18. The pin 26 can be secured to the connecting links 12 using a variety of methods, such as deforming an end 34 of the pin, attaching a cotter pin, or another suitable attaching mechanism. Alternatively, the blocking member 20 may be attached to the side plates 16 and 18 by bolting, screwing, riveting, or the like. It may also be desirable, in certain instances, to fixedly attach the blocking member 20 to the side plates 16 and 18. Under those circumstances, other attachment methods, such as welding, adhesives, or the like, may also be used for attaching the blocking member 20 to the side plates 16 and 18.

The roller links 14 are preferably configured similar to the connecting links 12. The roller links 14 include a first side plate 36 and a second side plate 38. The side plates 36 and 38 preferably have the same shape as the side plates 16 and 18 of the connecting links 12. This enables the side plates to be used interchangeably, while also eliminating the possibility that the connecting links 12 and roller links 14 may be inadvertently assembled using a wrong side plate. It shall be appreciated, however, that it is not necessary that the side plates 36 and 38 of the roller links 14 be configured the same as the side plates 16 and 18 of the connecting links 12. Likewise, it is also not necessary that the side plate 36 have the same shape as the side plate 38.

The roller links 14 include a blocking member 40 retentively positioned between the side plates 36 and 38 using a pin 42. The blocking member 40 preferably has an outer diameter that is substantially equal to that of the blocking member 20 of the connecting links 12. To facilitate assembly of the connecting links 12 to the roller links 14, the blocking member 20 preferably has an axial length “L1” less than the axial length “L2” of the blocking member 40. The axial length L1 of the blocking member 20 is determined by selecting an axial length that will result in the connecting links 12 having an outside width (the distance from the outside surface of the side plate 16 to the outside surface of the side plate 18) that is less than the inside width (the distance between the inside surface of the side plate 36 and the inside surface of the side plate 38) of the roller link 14. The blocking member 40 can be affixed to the side plates 36 and 38 using any of the methods previously described for attaching the blocking member 20 to the side plates. 16 and 18 of the connecting links 12.

The chain 10 includes a one or more connecting links 12 pivotally connected to one or more roller links 14. One end of the connecting links 12 is attached to one end of the roller links 14 by placing the end of the connecting links 12 into a nested position within the end of the roller links 14. The connecting links 12 are pivotally attached to the roller links 14 using a pin 46. The pin 46 has an outer periphery 48 that simultaneously engages an aperture 50 in the side plate 36 of the roller links 14, an aperture 52 in the side plate 16 of the connecting links 12, an aperture 54 in the side plate 18 of the connecting links 12, and an aperture 56 in the side plate 38 of the roller links 14. The pin 46 can be secured to the connecting links 12 and 14 using a variety of methods, such as deforming an end 58 of the pin, attaching a cotter pin, or another suitable attaching mechanism. Alternatively, the connecting links 12 may be attached to the roller links 14 by bolting, screwing, or the like. A plurality of the connecting links 12 and the roller links 14 can be connected together in an alternating sequence using the pin 46 to form a chain 10 of a desired length.

In operation, the angular orientation of the connecting links 12 and the roller links 14 can be varied with respect to one another by pivoting the links about the connecting pin 46. The blocking members 20 and 40 function as stops by limiting the angular rotation of the links in at least one direction. For example, it is possible for two adjacent links 12 and 14 to be pivoted relative to one another in a direction that causes the blocking members 20 and 40 to move toward each other. Further pivoting of the links causes the blocking members 20 and 40 to contact, thereby preventing the links from being further pivoted relative to one another.

The angular position of the connecting links 12 relative to the roller links 14 is a function of the diameter “D” of the blocking members and the distance “S” between successive connecting pins 46 when the blocking members 20 and 40 are in contact. If the diameter D of the blocking members is substantially equal to the distance S between successive pins 46, the longitudinal axis of the connecting links 12 (defined by an imaginary line intersecting the centers of the aperture 52 and an aperture 57 of the first side plate 16) and the longitudinal axis of the rolling links 14 (defined by an imaginary line intersecting the centers of the aperture 50 and an aperture 59 of first side plate 36) will form an angle of substantially 180 degrees. If the diameter D of the blocking members is greater than the distance S between successive pins 46, the longitudinal axis of the connecting links 12 and the longitudinal axis of the roller links 14 will form an angle greater than 180 degrees when measured from a side of the chain 10 on which the blocking members are positioned. If the diameter D of the blocking member is less than the distance S between successive pins 46, the longitudinal axis of the connecting links 12 and the longitudinal axis of the rolling links 14 will form an angle less than 180 degrees when measured from the side of the chain 10 on which the blocking members are positioned. This of course, is dependant on the blocking members 20 and 40 being positioned an equal distance from the pins 46.

Referring to FIG. 2, there is shown an alternate embodiment of a chain 61 utilizing a box-shaped blocking member 62 and 64 in place of the cylindrically shaped blocking members 20 and 40, respectively. The blocking member 62 is fixedly attached to a connecting link 65 and the blocking member 64 is fixedly attached to a roller link 67. The blocking member 62 includes a first surface 70 and an opposite surface 72 oriented substantially parallel to the first surface 70. Likewise, the blocking member 64 includes a first surface 74 and an opposite surface 76 oriented substantially parallel to the first surface 74.

The blocking member 62 is preferably attached to a first side plate 64 and a second side plate 66 of the connecting link 65 using two or more pins 68. Using at least two pins 68 prevents the blocking member 62 from rotating about the pins 68. The pins 68 can be secured to the connecting link 65 using a variety of methods, such as deforming an end 69 of the pin, attaching a cotter pin, or another suitable attaching mechanism. Alternatively, the blocking member 62 may be attached to the side plates 64 and 66 by bolting, screwing, welding, or the like.

In a similar fashion, the blocking member 64 is preferably connected to a first side plate 78 and a second side plate 80 of the roller link 67 using two or more pins 82. The pins 82 can be secured to the roller link 67 using a variety of methods, such as deforming an end of the pin (not shown), attaching a cotter pin, or another suitable attaching mechanism. Alternatively, the blocking member 64 may be attached to the side plates 78 and 80 by bolting, screwing, welding, or the like.

To facilitate assembly of the connecting link 65 to the roller link 67, the blocking member 62 preferably has a width “W1” less than a width “W2” of the blocking member 64. The width W1 of the blocking member 62 is determined by selecting a width that will result in the connecting link 65 having an outside width (the distance from the outside surface of side plate 64 to the outside surface of side plate 66) that is less than an inside width of the roller link 67 (the distance between the inside surface of side plate 78 and the inside surface of side plate 80).

The chain 61 includes a one or more of the connecting links 65 pivotally connected to or more of the roller links 67. One end of the connecting link 65 is attached to one end of the roller link 67 by placing the end of the connecting link 65 into a nested position within the end of the roller link 67. The connecting link 65 is pivotally attached to the roller link 67 using a pin 84. The pin 84 has an outer periphery 86 that simultaneously engages an aperture 88 in the side plate 78 of the roller link 67, an aperture 90 in the side plate 64 of the connecting link 65, an aperture 92 in the side plate 66 of the connecting link 65, and an aperture 94 in the side plate 80 of the roller link 67. The pin 84 can be secured to the connecting links 65 and the roller links 67 using a variety of methods, such as deforming an end 96 of the pin, using a cotter pin, or another suitable attaching mechanism. The chain 61 operates in the same manner as the chain 10, wherein the blocking members 62 and 64 function as stops by limiting the angular rotation of adjacent links 65 and 67 in at least one direction.

While various aspects of the anti-back flex chain have been disclosed, it will be appreciated that many other variations may be incorporated without departing from the scope of the present invention. For example, the blocking members may be positioned along one or both sides of the chain. Furthermore, the blocking members may also have a variety of other shapes. In addition, it is also envisioned that links having different shaped blocking members may be incorporated into the same chain. It is intended by the following claims to cover these and any other departures from the disclosed embodiments that fall within the true spirit of the invention. The description of the invention is merely exemplary in nature and, thus, variations that do not depart from the gist of the invention are intended to be within the scope of the invention. Such variations are not be regarded as a departure from the spirit and scope of the invention.

What is claimed is:

1. A chain comprising:
a first link having a first blocking member;
a second link having a second blocking member, the second link pivotally attached to the first link; and
the first blocking member having an exterior periphery engageable with an exterior periphery of the second blocking member when the first link and the second link are positioned in a first position relative to one another, the exterior periphery of the first blocking member being displaced from the exterior periphery of the second blocking member when the first link and the second link are positioned in a second position relative to one another.

2. The chain of claim 1, wherein:
the first link comprising a first plate having a first aperture; and
the second link comprising a second plate having a second aperture, whereby the first link is positionable relative to the second link such that a centerline of the first aperture of the first plate substantially coincides with a centerline of the second aperture of the second plate; and
a pin for pivotally connecting the first plate to the second plate, the pin having an external periphery engageable with the first aperture of the first plate and the second aperture of the second plate.

3. The chain of claim 2, wherein:
the first plate further comprising a second aperture, whereby the geometric centers of the first and second apertures of the first plate define a longitudinal axis of the first plate;
the second plate further comprising a first aperture, whereby the geometric centers of the first and second apertures of the second plate define a longitudinal axis of the second plate.

4. The chain of claim 3, wherein:
an exterior peripheral dimension of the first blocking member, measured parallel to the longitudinal axis of the first plate, is substantially equal to the distance between the first and the second apertures of the first plate; and
an exterior peripheral dimension of the second blocking member, measured parallel to the longitudinal axis of the second plate, is substantially equal to the distance between the first and second apertures of the second plate.

5. The chain of claim 4, wherein the longitudinal axis of the first plate is aligned substantially parallel to the longitudinal axis of the second plate when the first and second links are positioned in the first position.

6. The chain of claim 2, wherein:
an exterior peripheral dimension of the first blocking member, measured parallel to the longitudinal axis of the first plate, is less than the distance between the first and second apertures of the first plate; and
an exterior peripheral dimension of the second blocking member, measured parallel to the longitudinal axis of the second plate, is less than the distance between the first and second apertures of the second plate.

7. The chain of claim 6, wherein the longitudinal axis of the first plate and the longitudinal axis of the second plate form an angle less than 180 degrees measured from the opposite side of the chain on which the first and second blocking members are positioned.

8. The chain of claim 3, wherein:
an exterior peripheral dimension of the first blocking member, measured parallel to the longitudinal axis of the first plate, is greater than the distance between the first and second apertures of the first plate; and
an exterior peripheral dimension of the second blocking member, measured parallel to the longitudinal axis of the second plate, is greater than the distance between the first and second apertures of the second plate.

9. The chain of claim 8, wherein the longitudinal axis of the first plate and the longitudinal axis of the second plate form an angle greater than 180 degrees as measured from the opposite side of the chain on which the first and second blocking members are positioned.

10. The chain of claim 1, the first link comprising:
a first plate having a first projection extending laterally outward from the first plate;
a second plate having a second projection extending laterally outward from the second plate, the first plate positioned juxtapose to and spaced apart from the second plate; and
the blocking member retentively positioned between the first projection of the first plate and the second projection of the second plate.

11. The chain of claim 10, further comprising a first pin having an external periphery engageable with a first aperture defined by the first projection and a second aperture defined by the blocking member.

12. The chain of claim 11, wherein the external periphery of the first pin is engageable with an aperture defined by the second projection.

13. The chain of claim 10, further comprising:
a second pin having an external periphery engageable with a third aperture defined by the first plate;
a third pin having an external periphery engageable with a fourth aperture defined by the first plate, a geometric center of the third aperture and a geometric center of the fourth aperture defining a longitudinal axis of the first plate; and
wherein the first aperture is positionable relative to the third and fourth apertures such that an imaginary line intersecting the geometric center of the first aperture and oriented perpendicular to the longitudinal axis of the first plate intersects the longitudinal axis of the first plate at a point intermediate the third and fourth apertures.

14. The chain of claim 1, the second link comprising:
a first plate having a first projection extending laterally outward from the first plate;
a second plate having a second projection extending laterally outward from the second plate;
the first plate positioned juxtapose to and spaced apart from the second plate; and
the blocking member retentively positioned between the first projection of the first plate and the second projection of the second plate.

15. The chain of claim 14, further comprising a first pin having an external periphery engageable with a first aperture defined by the first projection and a second aperture defined by the blocking member.

16. The chain of claim 15, wherein the external periphery of the first pin is engageable with an aperture defined by the second projection.

17. The chain of claim 14, further comprising:
a second pin having an external periphery engageable with a third aperture defined by the first plate;
a third pin having an external periphery engageable with a fourth aperture defined by the first plate, a geometric center of the third aperture and a geometric center of the fourth aperture defining a longitudinal axis of the first plate; and
wherein the first aperture is positionable relative to the third and fourth apertures such that an imaginary line intersecting the geometric center of the first aperture and oriented perpendicular to the longitudinal axis of the first plate intersects the longitudinal axis of the first plate at a point intermediate the third and fourth apertures.

18. A chain link comprising:
a first plate having a first projection extending laterally outward from the first plate;
a second plate having a second projection extending laterally outward from the second plate, the first plate positioned juxtapose to and spaced apart from the second plate; and
a blocking member retentively positioned between the first projection of the first plate and the second projection of the second plate.

19. The chain link of claim 18, further comprising a first pin having an external periphery, wherein the external periphery of the first pin is engageable with a first aperture defined by the first projection and a second aperture defined by the blocking member.

20. The chain link of claim 19, wherein the external periphery of the first pin is engageable with an aperture defined by the second projection.

21. The chain link of claim 19, further comprising:
a second pin having an external periphery engageable with a third aperture defined by the first plate;
a third pin having an external periphery engageable with a fourth aperture defined by the first plate, a geometric center of the third aperture and a geometric center of the fourth aperture defining a longitudinal axis of the first plate; and
wherein the first aperture is positionable relative to the third and fourth apertures such that an imaginary line intersecting the geometric center of the first aperture and oriented perpendicular to the longitudinal axis of the first plate intersects the longitudinal axis of the first plate at a point intermediate the third and fourth apertures.

22. The chain link of claim 18, wherein the blocking member is rotatably attached to the first projection of the first plate.

23. The chain link of claim 22, wherein the blocking member is rotatable about an axis oriented substantially perpendicular to the first projection.

24. The chain link of claim 18, wherein the blocking member has a substantially cylindrical shaped external periphery.

25. The chain link of claim 18, wherein the blocking member comprises a substantially flat first external peripheral surface and a substantially flat second external peripheral surface aligned substantially parallel to the first external peripheral surface.

26. The chain link of claim 18, wherein the blocking member has a first end surface engageable with the first projection and a second end surface engageable with the second projection.

27. The chain link of claim 18, wherein the blocking member is fixedly attached to the first projection of the first plate.

28. The chain link of claim 18, wherein the first plate is oriented substantially parallel to the second plate.

29. The chain link of claim 18, wherein the first projection extends latterly outward from an edge surface of the fist plate.

30. The chain link of claim 18, wherein the second projection extends latterly outward from an edge surface of the second plate.
